(19) United States
(12) Patent Application Publication
(10) Pub. No.: US 2012/0161571 A1
(43) Pub. Date: Jun. 28, 2012

(54) MOTOR

(75) Inventors: Hiroshi FUKASAKU, Aichi-ken (JP); Taizo HIRANO, Aichi-ken (JP)

(73) Assignee: KABUSHIKI KAISHA TOYOTA JIDOSHOKKI, Kariya-shi (JP)

(21) Appl. No.: 13/336,585

(22) Filed: Dec. 23, 2011

(30) Foreign Application Priority Data
Dec. 24, 2010 (JP) 2010-288243

(51) Int. Cl. H02K 3/34

(52) U.S. Cl. 310/215

(57) ABSTRACT

A motor includes a rotor, a stator, an insulating member and a coil. The insulating member made of insulating films is inserted in a slot formed through a stator core of the stator. Cuff portions are formed in the coil-side insulating film by bending both ends thereof. An opening is formed in the coil-side insulating film at a region located at an intersection between a first bend line along which the coil-side insulating film is bent into a curved shape so as to fit the slot and a second bend line along which the coil-side insulating film is bent for forming the cuff portion. The stator core-side insulating film is laid on the coil-side insulating film such that the cuff portion overlaps a surface of the stator core-side insulating film on the stator core side and the stator core-side insulating film covers at least a part of the opening.

### BACKGROUND OF THE INVENTION

The present invention relates to an insulating member for use in a motor and disposed between a stator core of the motor and a coil arranged in a slot which is formed through the stator core.

In a conventional motor, an insulating member is interposed between the stator core of the motor and a coil arranged in a slot which is formed through the stator core for insulation therebetween.

Japanese Unexamined Utility Model Application Publication No. 54-22102 points out a problem that application of any pressure to the end of the coil during making a stationary core may break or bend the cuff portion of the slot cell that corresponds to the insulating member of the present invention, so that the slot cell may fail to serve for insulation (refer to FIG. 2 of the cited reference). In addition, another problem is pointed out by the cited reference that any damage caused to the cuff portion of the slot cell due to crack or abrasion of the cuff portion during making the stator core may cause short-circuiting between the stator core and the coil. To solve the problems, the above-mentioned Publication No. 54-22102 discloses an insulating member formed to have a reinforcement laid on the slot cell (refer to FIG. 2 of the cited reference).

Japanese Unexamined Utility Model Application Publication No. 58-136943 discloses an insulating member having a protective insulating film which is attached to the periphery of the insulating film with which the edge of the groove of the stator core is brought in contact during shaping of the coil end after insertion of the coil into the groove of the stator core for preventing a damage to the above periphery of the insulating film due to the contact between the periphery of the insulating film and the edge of the groove of the stator core.

Japanese Unexamined Patent Application Publication No. 9-117086 discloses an insulating member having two insulating films, namely the coil-side insulating film and the stator core-side insulating film, wherein one of the insulating film is made of polyethylene terephthalate (PET) film and the other is made of polyethylene naphthalate (PEN) film or polyphenylenesulfide (PPS) film (refer to FIG. 4(a) of the cited reference). For example, the coil-side insulating film is made of PEN film or PPS film, while the stator core-side insulating film is made of PET film (refer to FIG. 4(b) of the cited reference). As still another example, the coil-side insulating film is made of PET film, and the stator core-side insulating film is made of PEN film or PPS film (refer to FIG. 4(C) of the cirted reference).

A motor is used not only under a normal environment at normal temperature, but under a tough environment at high temperature and high humidity or at extremely low temperature. A typical example of motor used in tough and severe environment is a motor compressor for a vehicle air conditioner. The above-mentioned Publications No. 54-22102 and No. 58-136943 do not clearly refer to any specific material for the insulating member, but PET film and PEN film are popularly used for insulating member interposed between the stator core and the coil of a motor. However, these materials for insulating member pose problem when used under a tough and severe environment at high temperature and high humidity in that such materials are subjected to deterioration due to hydrolysis, with the result that damage such as checks or cracks are caused to the insulating films. When the motor is used under an environment at extremely low temperature, on the other hand, the PET film and PEN film are hardened, so that damage such as checks or cracks may be caused to the PET film and PEN film. As the damage of the insulating member progresses, fragments of the insulating member produced due to the damage may be dropped or scattered, so that there is a fear that the rotating parts of the motor are damaged. Especially, in the case of the motor compressor, micro fragments may flow with refrigerant in the refrigeration system, so that there is a fear that the motor compressor is damaged.

In the insulating member according to the above-mentioned Publication No. 9-117086, which is directed to preventing current leakage, PPS film which is more resistant than PET film and PEN film against an environment at high temperature and high humidity is used in combination with PET film and PEN film. Thus, the insulating member according to the Publication No. 9-117086 may be considered to be more effective to prevent damage such as checks or cracks due to deterioration, as compared to the insulating members disclosed in the Publications No. 54-22102 and No. 58-136943.

However, PPS film has poor workability, so that stress concentration tends to occur in the insulating member made of PPS film at a region located at an intersection between the bend line along which the PPS film is bent for forming a cuff portion of the insulating member and the bend line along which the PPS film is bent into a curved shape so as to fit a slot formed through the stator core. Thus, damage such as checks or cracks tends to occur in the PPS film when forming the PPS film, so that the PPS film may fail to provide sufficient insulation and fragments of the PPS film formed by the damage may be dropped and scattered within the motor. The cuff portion made of PET film or PEN film may be resistant against damage caused by bending when forming the cuff portion. However, stress generated by bending is concentrated in the film at a region located at the intersection between the bend lines, and damage in the film by deterioration tends to progress under an environment at high temperature and high humidity. Under an environment at extremely low temperature, on the other hand, the film is susceptible to damage due to hardening at low temperature. When the PET film or PEN film formed therewith a cuff portion is damaged, the damage tends to propagate in the insulating member. In the insulating member according to the above-mentioned Publication No. 9-117086, if a PPS film having resistance against deterioration is laid on PET film or PEN film without being bent, the PPS film tends to be dislocated and a clearance is formed between the films, with the result that the insulating member may fail to provide sufficient insulation.

The present invention is directed to preventing damage in an insulating member which is inserted in a slot formed through a stator core of a motor regardless of the environment under which the motor is used.

### SUMMARY OF THE INVENTION

In accordance with the present invention, a motor includes a rotor, a stator, an insulating member and a coil. The stator has a stator core through which a slot is formed. The insulating member is made by laying at least two insulating films and inserted in the slot. The coil is arranged in the slot with the insulating member interposed between the coil and the stator core. The insulating member is made of a coil-side insulating film on the coil side and a stator core-side insulating film on the stator core side. Cuff portions are formed in the coil-side insulating film by bending both ends of the coil-side insulating film and engaged with the stator core at end surfaces of the stator core. An opening is formed in the coil-side insulating film at a region located at an intersection between a first bend line along which the coil-side insulating film is bent into a curved shape so as to fit the slot and a second bend line along which the coil-side insulating film is bent for forming the cuff portion. The stator core-side insulating film is laid on the coil-side insulating film such that the cuff portion of the coil-side insulating film overlaps a surface of the stator core-side insulating film on the stator core side and the stator core-side insulating film covers at least a part of the opening.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a partial cutaway plan view showing a motor with an insulating member according to a first preferred embodiment of the present invention;

FIG. 2 is a perspective view showing a stator core of the motor of FIG. 1;

FIG. 3 is an enlarged top view showing a slot formed through the stator core of FIG. 2, as viewed from an end of the stator core;

FIG. 4 is an enlarged inside view showing the slot of FIG. 3, as viewed from the inside of the stator core;

FIG. 5 is a perspective view showing the insulating member for the motor of FIG. 1 to be inserted into the slot;

FIG. 6 is a schematic view showing a process for forming a coil-side insulating film of the insulating member of FIG. 5;

FIG. 7 is a schematic view showing a process for making the insulating member by laying a stator core-side insulating film on the coil-side insulating film of the insulating member of FIG. 5;

FIG. 8 is a schematic view showing a process for making an insulating member for a motor according to a second preferred embodiment of the present invention by laying a stator core-side insulating film on a coil-side insulating film; and

FIG. 9 is an enlarged top view showing a slot formed through a stator core of a motor according to a third preferred embodiment of the present invention, as viewed from an end of the stator core.

### DETAILED DESCRIPTION OF THE PREFERRED EMBODIMENTS

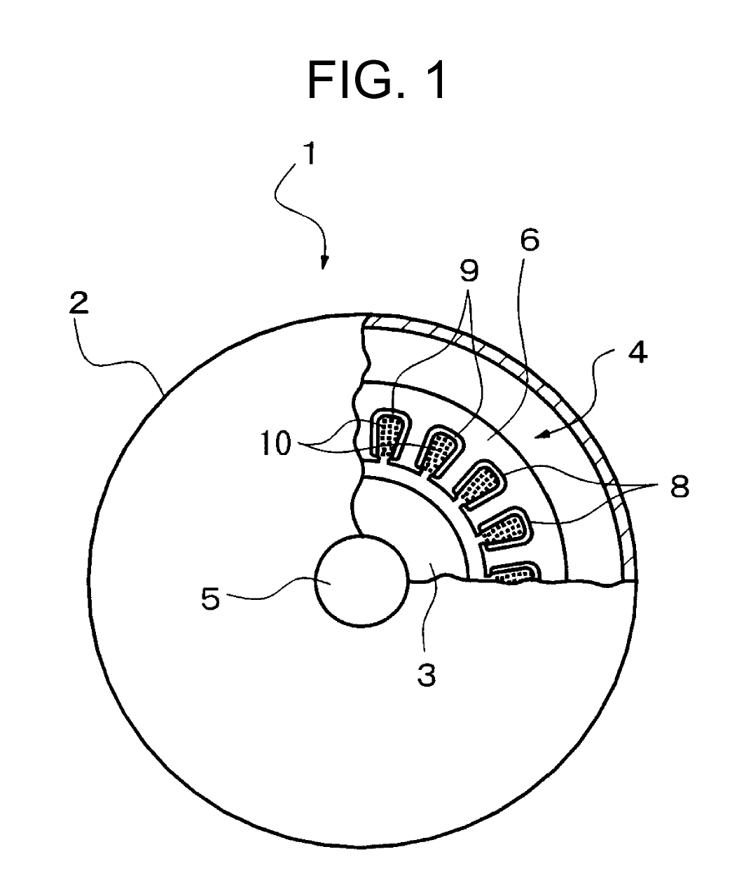

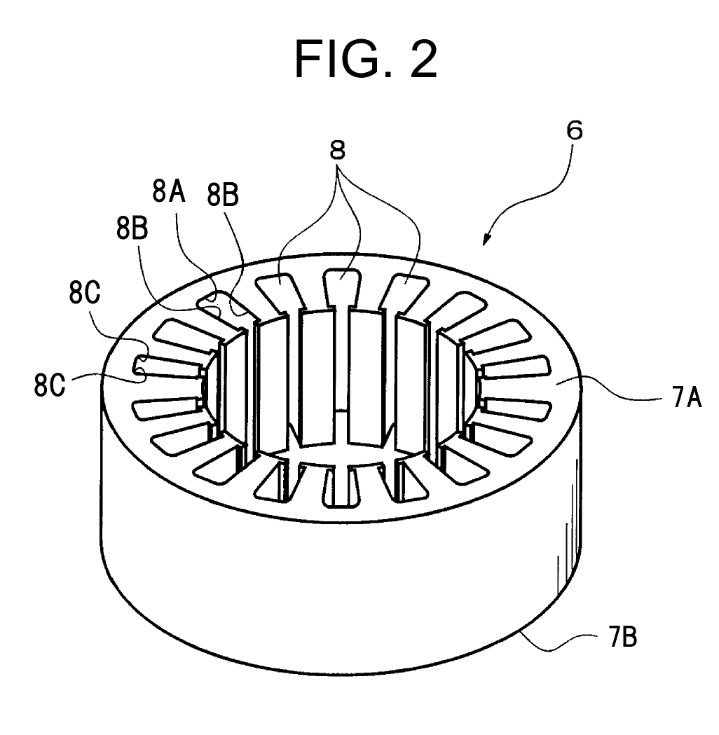

The following will describe an insulating member for a motor according to a first preferred embodiment of the present invention with reference to FIGS. 1 through 7. Referring to FIG. 1, a motor is designated generally by numeral 1 has a case 2, a rotor 3 and a stator 4. The rotor 3 and the stator 4 are disposed in the case 2 and the stator 4 is disposed around the rotor 3. The rotor 3 is fixed on a rotary shaft 5 which is rotatably mounted in the case 2 at the center thereof. The stator 4 has a stator core 6. Referring to FIG. 2, the stator core 6 has top and bottom surfaces 7A and 7B, and a plurality of slots 8 is formed through the stator core 6, each extending between the top and bottom surfaces 7A and 7B and having an opening facing inward or the rotor 3. As shown in FIG. 1, each slot 8 has therein a coil 10 and an insulating member 9 arranged in such a way the insulating member 9 is interposed between the coil 10 and the stator core 6.

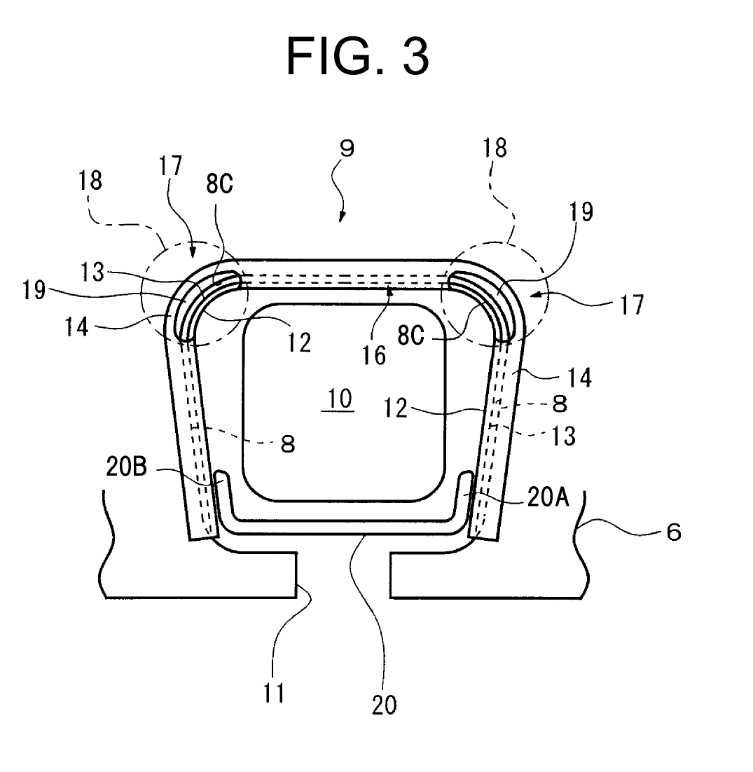

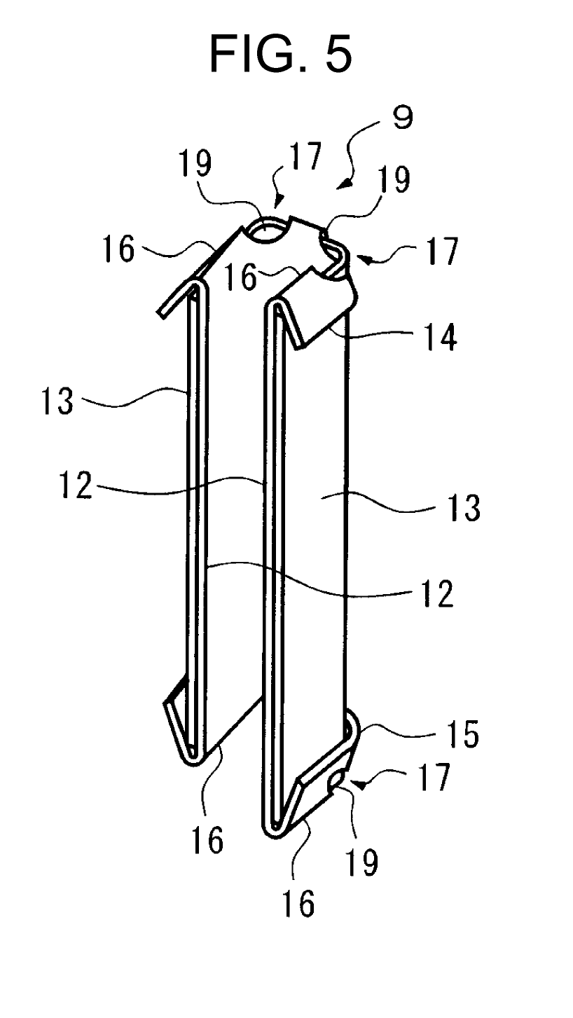

FIGS. 2 through 4 show the structure of the slot 8 in detail, respectively. Each slot 8 is formed so as to have a trapezoidal shape as seen in a plane extending parallel to the opposite ends of the stator core 6, having two side extending convergently inwardly. As indicated above, the slot 8 is formed with an opening 11 facing inward as shown in FIG. 3, or facing the rotor 3 (not shown in FIG. 3). The slot 8 of trapezoidal shape is formed by a flat inner wall surface 8A positioned deepest within the slot 8, two flat inner wall surfaces 8B extending substantially in the radial directions of the stator core 6 on opposite side of the flat inner wall surface 8A and two arcuate inner wall surfaces 8C having a small radius of curvature and connecting between any two adjacent inner wall surfaces 8A and 8B. Referring to FIG. 5, the insulating member 9 inserted in the slot 8 is made of two insulating films, namely an insulating film 12 on coil side (coil-side insulating film 12 hereinafter) laid on an insulating film 13 on stator core side (stator core-side insulating film 13 hereinafter). The coil-side insulating film 12 and the stator core-side insulating film 13 are made of polyphenylenesulfide (PPS) film which is less susceptible to degradation due to hydrolysis.

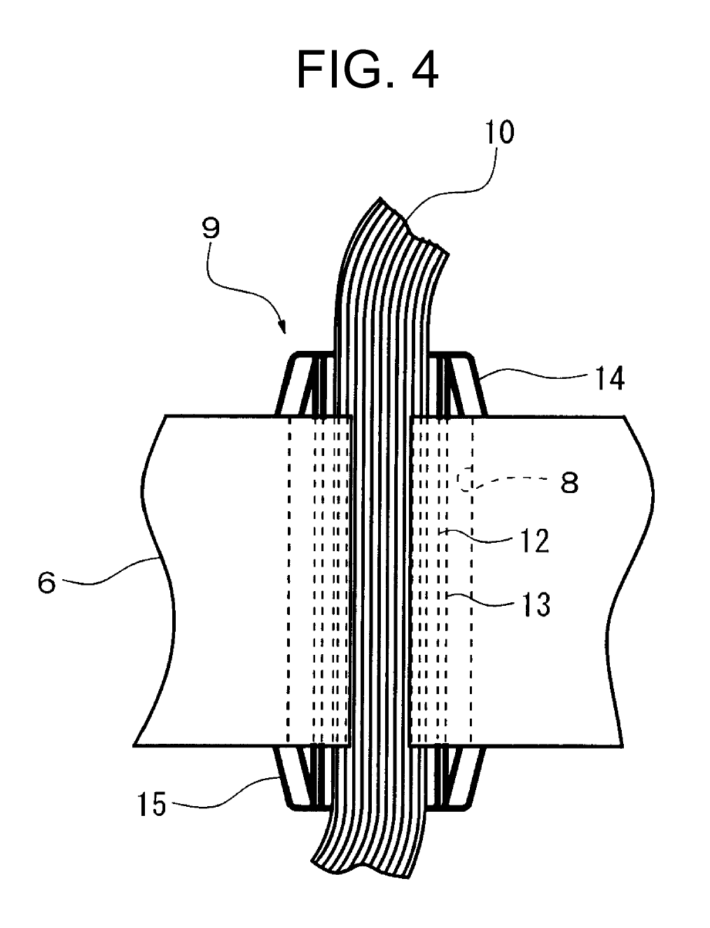

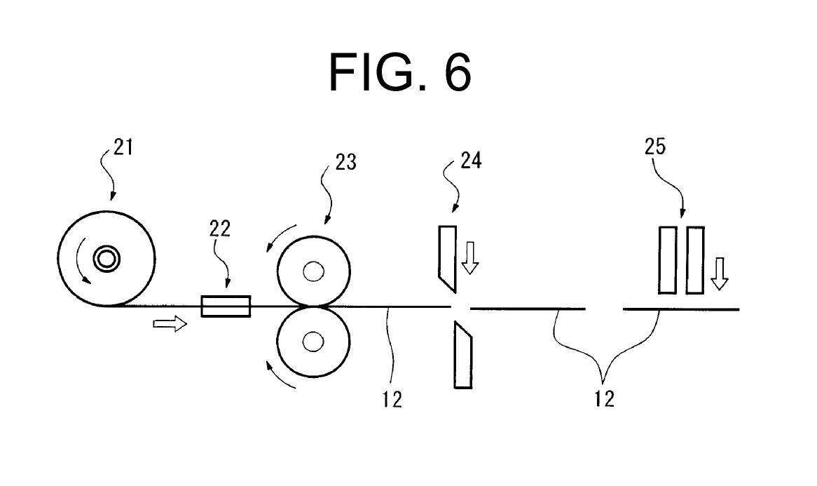

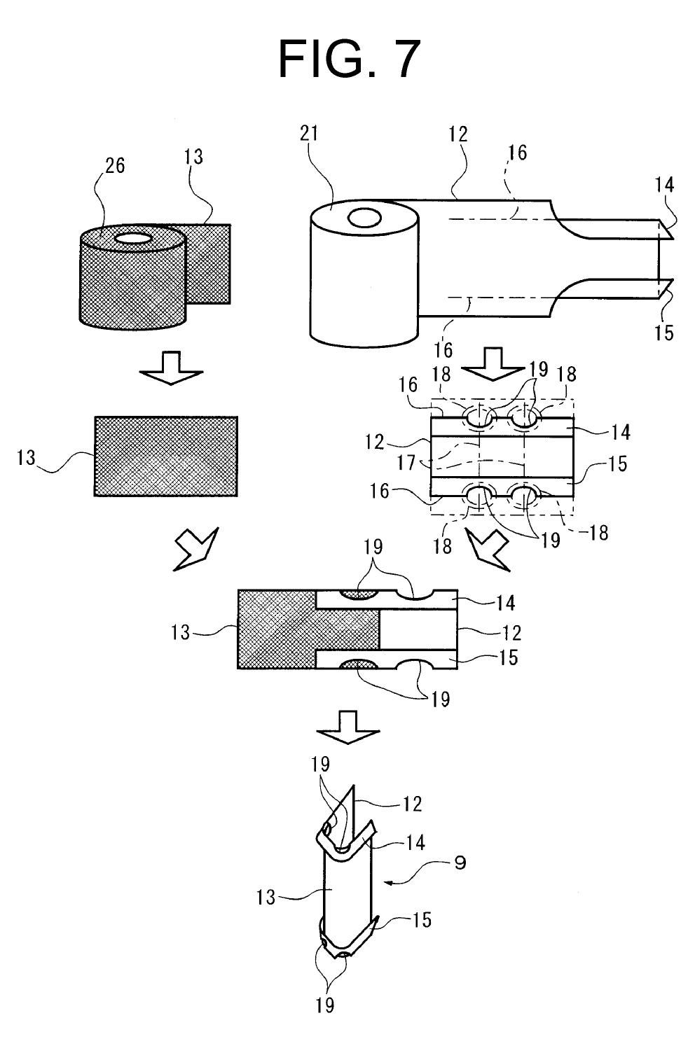

The coil-side insulating film 12 of the insulating member 9 is cut to have a length corresponding to the dimension of the slot 8 as measured along the surfaces of the arcuate inner wall surfaces 8A, 8B, 8C shown in FIGS. 6 and 7. The coil-side insulating film 12 has cuff portions 14, 15 formed by bending outward both ends or the upper and lower ends thereof, as shown in FIGS. 4, 5, and 7. The coil-side insulating film 12 is bent along the second bend lines 17 into a U-shape in cross section thereof so as to fits the slot 8. The cuff portions 14 and 15 are bent outward along the first bend lines 16 shown in FIGS. 5 and 7 and the coil-side insulating film 12 is bent along the second bend lines 17 shown in FIGS. 5 and 7 into a curved shape. As shown in FIGS. 3 and 7, numeral 18 designates a region located at an intersection between the first and second bend lines 16, 17. Openings 19 are formed in the coil-side insulating film 12 at the regions 18, respectively. A total of four openings 19 is formed in the coil-side insulating film 12, namely two openings 19 at the regions 18 around the top of the coil-side insulating film 12 and another two openings 19 at the regions 18 at the bottom of the coil-side insulating film 12. The cuff portions 14, 15 are engaged with the stator core 6 at the end surfaces or the top and bottom surfaces 7A, 7B thereof, thus serving to prevent the insulating member 9 from falling off from the stator core 6.

The stator core-side insulating film 13 is a flat rectangular-shaped film having a length whose dimension is substantially the same as the length of the coil-side insulating film 12 and a width whose dimension is substantially the same as or slightly smaller than the distance between the top and bottom first bend lines 16 of the coil-side insulating film 12. Such rectangular-shaped stator core-side insulating film 13 is laid on the coil-side insulating film 12 in the region of the coil-side insulating film 12 between the top and bottom first bend lines 16 thereof and held in place by the top and bottom cuff portions 14 and 15 of the coil-side insulating film 12. The stator core-side insulating film 13 laid on the coil-side insulating film 12 completely covers the openings 19 formed in the coil-side insulating film 12. Thus, the insulating member 9 formed by the combination of the coil-side insulating film 12 and the stator core-side insulating film 13 provides successful insulation.

When the insulating member 9 is inserted in the slot 8, the coil-side insulating film 12 of the insulating member 9 is positioned on the side of the coil 10 with the cuff portions 14 and 15 engaged with the stator core 6 at the top and bottom thereof, and the stator core-side insulating film 13 is positioned on the side of the stator core 6 and held by the cuff portions 14 and 15 of the coil-side insulating film 12. The coil 10 is arranged in the slot 8 of the stator core 6 with the insulating member 9 interposed between the coil 10 and the stator core 6. As shown in FIG. 3, a coil cap 20 is inserted in the slot 8 so as to seal the opening 11 of the slot 8 thereby to prevent any part of the coil 10 from extending out through the opening 11 of the slot 8. The coil cap 20 is made of PPS film. As shown in FIG. 3, the opposite end portions 20A and 20B of the coil cap 20 are slightly bent inward of the slot 8 and placed in contact with the coil-side insulating film 12 for insulating between the stator core 6 and the coil 10. FIG. 4 shows the structures of the slot 8, the insulating member 9 and the coil 10 with the coil cap 20 which is omitted from the illustration.

FIGS. 6 and 7 illustrate a process for making the insulating member 9. Referring firstly to FIG. 6, a film sheet for the coil-side insulating film 12 is drawn from an insulating film roll 21 by a film drawing rollers 23. The film sheet for the coil-side insulating film 12 is bent at the opposite sides thereof along the first bend lines 16 by a bending jig 22 thereby to be formed with the cuff portions 14, 15. Then, the film sheet for the coil-side insulating film 12 passed through the film drawing rollers 23 is cut by a cutter 24 into a rectangular shape having a length corresponding to the dimension of the slot 8.

The film sheet for the coil-side insulating film 12 formed with the cuff portions 14, 15 and cut into the predetermined length is positioned such that four portions corresponding to the regions 18 located at the intersections between the first bend lines 16 for bending the film sheet for the coil-side insulating film 12 to form the cuff portions 14, 15 and the second bend lines 17 for bending the film sheet for the coil-side insulating film 12 so as to fit the slot 8 are located at positions for forming the openings 19, respectively. The openings 19 are formed in the film sheet for the coil-side insulating film 12 at positions corresponding to the regions 18 by an opening forming machine 25 thereby to form the coil-side insulating film 12.

Referring to FIG. 7, a film sheet for the stator core-side insulating film 13 having a width that is substantially the same as or slightly smaller than the distance between the top and bottom first bend lines 16 of the coil-side insulating film 12 is drawn from a film roll 26. The film sheet for the stator core-side insulating film 13 is drawn from the film roll 26 by rollers similar to the film drawing rollers 23 and cut by a cutter similar to the cutter 24 into a rectangular shape having a predetermined length thereby to form the stator core-side insulating film 13. The stator core-side insulating film 13 is inserted in the coil-side insulating film 12 between the cuff portions 14 and 15 thereof. The stator core-side insulating film 13 laid on the coil-side insulating film 12 can sealingly cover the openings 19 of the coil-side insulating film 12 at the regions 18.

The insulating member 9 is formed by bending the coil-side insulating film 12 and the stator core-side insulating film 13 by using a bending machine (not shown) into a U-shape so as to fit the slot 8 as shown in FIG. 5.

The first preferred embodiment of the present invention offers the following advantageous effects. After the cuff portions 14, 15 are formed in the coil-side insulating film 12, the insulating member 9 is formed by bending the film sheet for the coil-side insulating film 12 formed with the openings 19 and the stator core-side insulating film 13 laid on the coil-side insulating film 12 into a U-shape so as to fit the slot 8. Since the radius of curvature of the arcuate inner wall surface 8C of the a slot 8 which is formed at the region 18 and connects between the inner wall surfaces 8A and 8B of the slot 8 is substantially small, the coil-side insulating film 12 bent at the region 18 receives at the region 18 located at an intersection between the first and second bend lines 16, 17 concentrated stress.

According to the first preferred embodiment of the present invention, however, the openings 19 are formed in the coil-side insulating film 12 at the regions 18, and parts of the intersection between the first and second bend lines 16, 17 are cut away from the coil-side insulating film 12, so that the occurrence of the stress concentration at the regions 18 is avoided, effectively. Moreover, parts of the intersection between the first and second bend lines 16, 17 having a wide area may be cut away from the coil-side insulating film 12, so that the effect achieved by avoiding the occurrence of the stress concentration at the regions 18 is relatively large. Thus, damage such as checks or cracks in the insulating member 9 which may occur when forming the insulating member 9 is prevented, so that successful insulation between the stator core 6 and the coil 10 is achieved regardless of the environment in which the motor 1 is used, and the lifetime of the insulating member 9 can be extended. In addition, while the openings 19 are formed in the coil-side insulating film 12, the insulation is achieved sufficiently since the openings 19 are covered completely by the stator core-side insulating film 13.

In addition, since the process of making the insulating member 9 may be done with the process of forming the openings 19, the openings 19 may be easy to form.

The use of PPS film for both of the coil-side insulating film 12 and the stator core-side insulating film 13 of the insulating member 9 helps to prevent damage in and deterioration of the insulating member 9 due to the usage under severe environment at high temperature and high humidity and may reduce the cost of making the insulating member 9, in comparison with the case where polyethylene terephthalate (PET) film and polyethylene naphthalate (PEN) film are used for the insulating films 12, 13.

Through the insulating member 9 is made by only two insulating films, the above-mentioned advantageous effects may be obtained, and there is no fear that the insulating member 9 is complicated in structure thereby to raise the cost of making the insulating member 9.

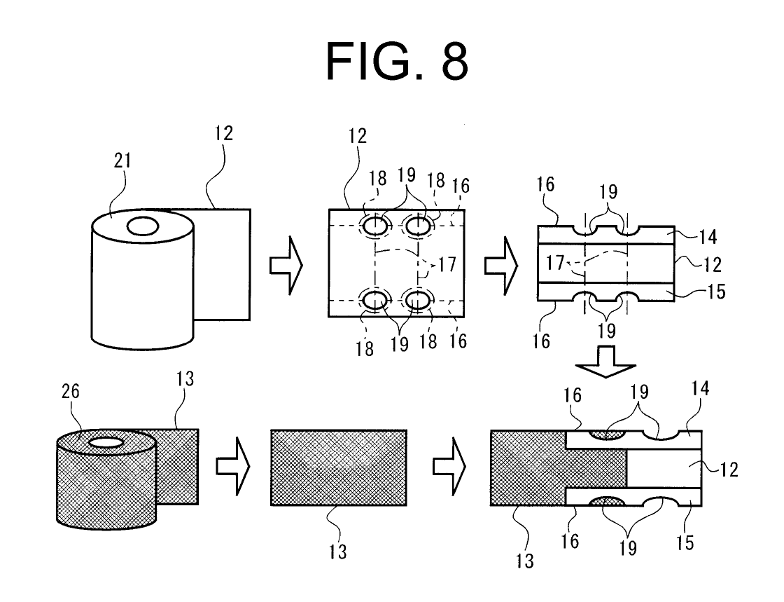

The following will describe a second preferred embodiment of the present invention with reference to FIG. 8. The second preferred embodiment differs from the first preferred embodiment in the process for forming the insulating member 9. The same reference numerals will be used to denote those components or elements which correspond to the counterparts of the first preferred embodiment and the description thereof will not be reiterated. According to the second preferred embodiment of the present invention, firstly, a film sheet for the coil-side insulating film 12 is cut from the insulating film roll 21 into a rectangular shape having the aforementioned length. The openings 19 are formed in the film sheet for the coil-side insulating film 12 at positions corresponding to the four regions 18 located at intersections between the first and second bend lines 16, 17. Then, the top and bottom portions of the film sheet for the coil-side insulating film 12 are bent along the first bend lines 16 thereby to form the cuff portions 14, 15 thereby to form the coil-side insulating film 12. As is apparent from the above, the coil-side insulating film 12 of the second preferred embodiment is substantially the same in structure as the coil-side insulating film 12 of the first preferred embodiment shown in FIG. 7.

The film sheet for the stator core-side insulating film 13 is formed in the same process as that in the first preferred embodiment of the present invention, and then laid on the coil-side insulating film 12 having formed therein the openings 19 and the cuff portions 14, 15. Subsequently, the combined coil-side insulating film 12 and the stator core-side insulating film 13 are bent in a U-shape so as to fit the slot 8. The second preferred embodiment offers the same advantageous effects as the first preferred embodiment.

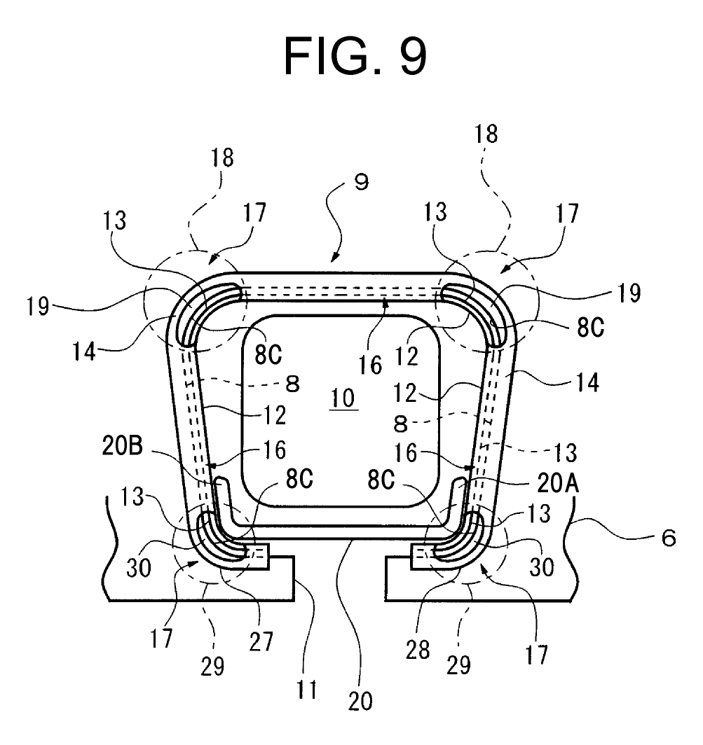

The following will describe a third preferred embodiment of the present invention with reference to FIG. 9. The third preferred embodiment differs from the first preferred embodiment in the shape of the insulating member 9. The same reference numerals will be used to denote those components or elements which correspond to the counterparts of the first preferred embodiment and the description thereof will not be reiterated. According to the third preferred embodiment of the present invention, the opposite ends 27, 28 of the insulating member 9 adjacent to the opening 11 of the slot 8 are bent inwardly or toward each other. In FIG. 9, numerals 29 designate regions located at an intersection between the first and second bend lines 16, 17, or the ends of the insulating member 9.

The openings 30 are formed in the coil-side insulating film 12 at the regions 29 as in the case of the regions 18 for preventing stress concentration in the coil-side insulating film 12 at the regions 29. Thus, the openings 30 formed in the coil-side insulating film 12 serve to prevent damage such as checks or cracks in the insulating member 9, so that the advantageous effects of the first preferred embodiment are obtained.

The present invention is not limited to the embodiments described above, but it may be modified into various alternative embodiments as exemplified below.

(1) According to the first through third preferred embodiments of the present invention, the coil-side insulating film 12 and the stator core-side insulating film 13 of the insulating member 9 are made of PPS film. Alternatively, the stator core-side insulating film 13 may be made of PPS film, and the coil-side insulating film 12 may be made of PET film or PEN film. Thus, the coil-side insulating film 12 and the stator core-side insulating film 13 may be bent more easily when forming the cuff portions in the coil-side insulating film 12 or bending the insulating films 12, 13 into a curved shape so as to fit the slot of the stator core. At least, the stator core-side insulating film 13 may be made of a film having resistance against degradation due to hydrolysis.
(2) According to the first through third preferred embodiments of the present invention, the insulating member 9 is formed by laying one of two films of the coil-side insulating film 12 and the stator core-side insulating film 13 on the other film. In other words, the insulating member 9 is formed by laying two insulating films consisting of one coil-side insulating film 12 and one stator core-side insulating film 13. Alternatively, the insulating member 9 may be formed by combining three or more films as may be necessary.
(3) According to the first through third preferred embodiments of the present invention, the openings 19, 30 are formed by elongated holes. Alternatively, the openings 19, 30 may be formed by any circular holes, fan-shaped holes or polygon-shaped holes having three or more sides.
(4) The openings 19, 30 may be formed in the coil-side insulating film 12 by a straight slit, a cut formed by a knife or a scissors, or a notch with a groove.
(5) According to the first through third preferred embodiments of the present invention, the slot 8 is formed in a trapezoid shape in cross section, as shown in FIG. 2. Alternatively, the slot 8 may be formed by one arcuate surface like the inner wall surface 8A and two arcuate inner wall surfaces like arcuate inner wall surface 8C, or formed by one arcuate surface formed by connecting two inner wall surfaces like the inner wall surfaces 8B through one arcuate surface like the arcuate inner wall surface 8C. In this case, openings are also formed at regions located at an intersection between the first and second bend lines.
(6) According to the first through third preferred embodiments of the present invention, the openings 19, 30 are formed in the coil-side insulating film 12 at the regions 18, 29. Alternatively, one opening may be formed at a region which includes the adjacent two regions 18, 29.
(7) The insulating members according to the first through third preferred embodiments of the present invention have been described as applied to a general type motor. The insulating member according to the present invention may applied advantageously to a motor in a motor compressor for a vehicle air conditioner which is used under a severe environment at high temperature, high humidity and heavy vibration.
(8) According to the first through third preferred embodiments of the present invention, the openings 19 are formed in the coil-side insulating film 12, and the openings 19 are covered completely by the stator core-side insulating film 13. Alternatively, the openings 19 may not be covered completely by the stator core-side insulating film 13 if the insulation is achieved sufficiently.

What is claimed is:

1. A motor comprising:
a rotor;
a stator having a stator core through which a slot is formed;
a insulating member made by laying at least two insulating films, the insulating member inserted in the slot; and
a coil arranged in the slot with the insulating member interposed between the coil and the stator core,
wherein the insulating member is made of a coil-side insulating film on the coil side and a stator core-side insulating film on the stator core side,
cuff portions are formed in the coil-side insulating film by bending both ends of the coil-side insulating film and engaged with the stator core at end surfaces of the stator core,
an opening is formed in the coil-side insulating film at a region located at an intersection between a first bend line along which the coil-side insulating film is bent into a curved shape so as to fit the slot and a second bend line along which the coil-side insulating film is bent for forming the cuff portion,
and the stator core-side insulating film is laid on the coil-side insulating film such that the cuff portion of the coil-side insulating film overlaps a surface of the stator core-side insulating film on the stator core side and the stator core-side insulating film covers at least a part of the opening.

2. The motor according to claim 1, wherein the insulating member is formed by laying two insulating films consisting of one coil-side insulating film and one stator core-side insulating film.

3. The motor according to claim 1, wherein all films forming the insulating member are made of polyphenylenesulfide film.

4. The motor according to claim 1, wherein the coil-side insulating film is made of polyethylene terephthalate film or polyethylene naphthalate film, and the stator core-side insulating film is made of polyphenylenesulfide film.

5. The motor according to claim 1, wherein the opening is a circular hole formed through the coil-side insulating film.

6. The motor according to claim 1, wherein the opening is formed before or after forming the cuff portions.

7. The motor according to claim 1, wherein the motor is a motor in a motor compressor for a vehicle air conditioner.
